(19) United States
(12) Patent Application Publication
(10) Pub. No.: US 2011/0146043 A1
(43) Pub. Date: Jun. 23, 2011

(54) TOOL AND METHOD FOR SAFE REMOVAL OF VALVES FITTED IN FLUID PIPES

(75) Inventors: Jairo Alberto Canal Rivera, Santander (CO); Hamberto Reyes Gomez, Santander (CO); Henry Castaneda Camacho, Santander (CO)

(73) Assignee: ECOPETROL S.A., BOGOTA (CO)

(21) Appl. No.: 12/517,994

(22) PCT Filed: Dec. 11, 2007
(86) PCT No.: PCT/IB07/04329

§ 371 Date: Mar. 8, 2011

(30) Foreign Application Priority Data
Nov. 12, 2006 (CO) 06123320

(51) Int. Cl. F16L 55/168; F16L 55/18

(52) U.S. Cl. 29/221.6; 137/15.08

(57) ABSTRACT

This invention relates to a manual tool for safely removing undesired taps, connected illegally and controlled by means of locking valves in fluid transport pipes (especially oil and derivatives thereof) and with pressures present of up to 690 kPa (100 psi). The tool according to the present invention is formed by a handle, a handle shaft, a packing gland, a main body, a draining valve, and a gauge adapter or wood plug, which is inserted by friction in the perforation to be blocked, forming a temporary seal therein while a definitive metal patch is fitted and soldered to the pipe. The invention also includes the method for safe removal of valves fitted to fluid pipes with said tool.

### FIELD OF THE INVENTION

This invention relates to a manual tool for safely removing undesired taps, connected illegally and controlled by means of locking valves in fluid transport pipes (especially oil and derivatives thereof) and with pressures present of up to 690 kPa (100 psi). The tool according to the present invention is formed by a handle, a handle shaft, a gasket carrier, a main body, a draining valve, and a gauge adapter or wood plug (named “calaján”), which is inserted by friction into the perforation to be blocked, forming a temporary seal therein while a definitive metal patch (named “cascota”) is fitted and soldered to the pipe. The invention also includes the method for safe removal of valves fitted to fluid pipes with said tool.

### OBJECT OF THE INVENTION

During transportation of fluids through conduits and specifically in the oil industry, sometimes taps are illegally installed in order to drain the fluid. In order to overcome such situation, once the tap is detected and the downstream installation has been eliminated thereof, it is necessary to proceed with the elimination of such tap in a coordinate manner with the tubing operation and the industrial and ecological protection of the environment. This activity can be carried out following the consecutive steps such as pumping suspension, pressure relief, fluid displacement, verification of the absence of explosive environment, tap elimination and soldering a metallic patch or “cascota”. During all this procedure, tubing is placed out of service, fuel is not delivered to a city/destination, costly qualified recourses are used and a lost profits situation for infrastructure appears.

In order to minimize the negative effect of the valve removal, the present invention was developed.

This tool can be widely applied to the oil and derivatives transport sector, for totally eliminating secondary taps on the main tubing. Different from the procedures and tools used in other inventions, the proposed tool uses and locates a wood consumable plug (named “calaján”) in the perforation to be blocked, in order to make a temporary seal therein while a definitive metal patch (named “cascota”) is installed and welded to the tubing.

Other invented tools for that same purpose utilize hydraulic drivers, but their dimensions bar the application onto the ducts which usually are buried. The present invention uses manual elements having small size easy to install.

The alternative inventions use elements such as balloons which must be introduced through the perforation and then must be inflated. These cannot be used with fluids that override certain pressure limits or in undesired perforations having diameters less than 2.5 cm (1 in).

The present invention widely overcome the difficulties found when using other inventions, through the advantages derived from its manual handling way, its size, its operation method and simple manufacturing, as described below.

### STATE OF THE ART

U.S. Pat. No. 6,446,662, titled “Device for drilling or plugging a hole in a sealed fluid container or conduit wall” claims the combination of a tool for installing a drill and a plug for perforating a circular hole through the conduit wall and then placing a plug. The plug radially expands when axially compressed for closing the hole and avoiding pressurized gas leakages which the tubing transports. The compressing force is applied to the plug through the action of two anchor type metal tabs and the fixation of the plug requires a rotating movement.

The device comprises an externally threaded elements at the top and part of the radially expansive plug body for holding and positioning the plug during installation. The externally threaded element is formed in one end as a removable device for interchanging a drill bit and a plug to seal the hole. The elongated axle is further formed for moving the externally threaded element and the plug linearly and rotationally by moving the axle and the element into the position and for tightly coupling the plug into the hole.

The tool of the present invention is only designed for blocking perforation and not for perforating tubing. In addition, the plug used herein is a consumable element (wood plug) which is fixed to the perforation wall by friction when forced into the perforation, different from that described in U.S. Pat. No. 6,446,662 in which the plug is fixed through the action of two metal tabs. In the present invention, fixation of the blocking element does not require a rotational movement, as in the US patent, only an axial displacement.

The tool of the present invention implements gauge elements for determining the perforation diameter and selecting the plug diameter which better fits thereof. This characteristic is not found in the mentioned patent, where it only describes a plug comprising an elastomeric material compressible cylinder body, which fits the perforation through the action of a compressing force exerted by the tool.

The Colombian Patent Application CO 05 128992 and the PCT IB2003/002595, “Hydraulic machine for withdrawing illicit valves in polyducts”, have as the object, similar to the present invention, a device for withdrawing valves on operating ducts. The described machine in the application CO 05 128992 is comprised by the assembled bodies: a first body corresponding to a hydraulic jack, a second displacement body for marking and a third body for supporting the wood element.

In opposition to the teachings of the patent Application CO 05 128992, the tool of the present invention is formed by one single body supported in wood elements and gauges, which use a needle valve. Its operation is manual which allow detecting the clogging of the wood plug when the perforation is completely sealed, while with the tool of the patent application CO 05 128992, which is hydraulically driven, there is no control on locating the plug with the possibility of its destruction in the operation with no wanted result obtained.

The tool of the present invention is manually driven and the plug can be fitted in the same way and fitting thereof is easily done by hitting on the tool's body.

Among the technical advantages of the present invention over the invention of application CO 05 128992, is that the tool herein taught is smaller than that of application CO 05 128992 so that it allows a more simple handling and operation; The measure of the displacement advance of the plug is done directly on the tool's bar and do not require another element as in the mentioned invention. The body's axle of the present invention returns to its position manually after installing the wooden plug into the perforation left by the tap valve. Different from the cited invention, which uses a lead device for marking the hole diameter, the herein claimed tool uses “pass-no-pass” gauges for measuring the hole size.

The patent DE60015536T: “A method of closing a pipe”, discloses a method designed for introducing an inflatable blocking apparatus in a tubing tap, in particular in a tap having a small diameter in which the blocking apparatus is being introduced.

As well as in the present application, this tool is also introduced through a previously welded tap to the tubing that will be blocked, but uses an inflatable balloon serving as blocking element in the perforation. In the present invention, instead of an inflatable balloon, a wooden plug element is used.

As in our invention, this tool is threaded into the blocking valve in the tap. Nevertheless, the operation principle of this tool is different to that implied in the tool of the present invention.

On the other hand, the Colombian utility model patent application No 04-112631, Flexible application antifraud Blocking system for aqueducts, discloses a system comprised by a flexible hose which in one end there is an expansion element threaded in an inner wire rope and in the other end has a handle for manipulating (rotating) said wire rope.

The present invention uses a wooden plug element which is fixated to the perforation for a friction blocking, while in said invention a plug attached to the perforation through expansion is used.

The referenced invention uses an expansible plug element applicable to a wide range of perforations, while our invention uses a wooden plug element fitted to each specific perforation diameter.

The Colombian patent application No. 04-31531, Safety device for blocking, refers to an invention consisting of a tool having an expansion element driven through two concentric metal tubes for generating the expansion by the relative rotation between them.

In our invention we have a wooden plug element which fits through friction into the perforation to be blocked.

In the above inventions there is no working pressure range given. In our invention a safe operation range was established up to 690 kPA (100 psi). This is found supported in experimental tests with wooden plugs having different diameters from ¾ in. (1.9 cm) to 1½ in. (3.81 cm) with a safety factor of 100%.

Accordingly, the present invention constitutes a solution to an existent technical problem related with safely withdrawal of valves installed in tubing which transport pressurized fluids, which is a manual operative tool that guarantee the blocking of a hole in the tubing and therefore represents an advantage over the tools which use a hydraulic blocking system.

### BRIEF DRAWINGS DESCRIPTION

FIG. 1. Teaches the tool for safely removing valves installed in fluid pipes, assembled and also each one of the parts forming thereof.

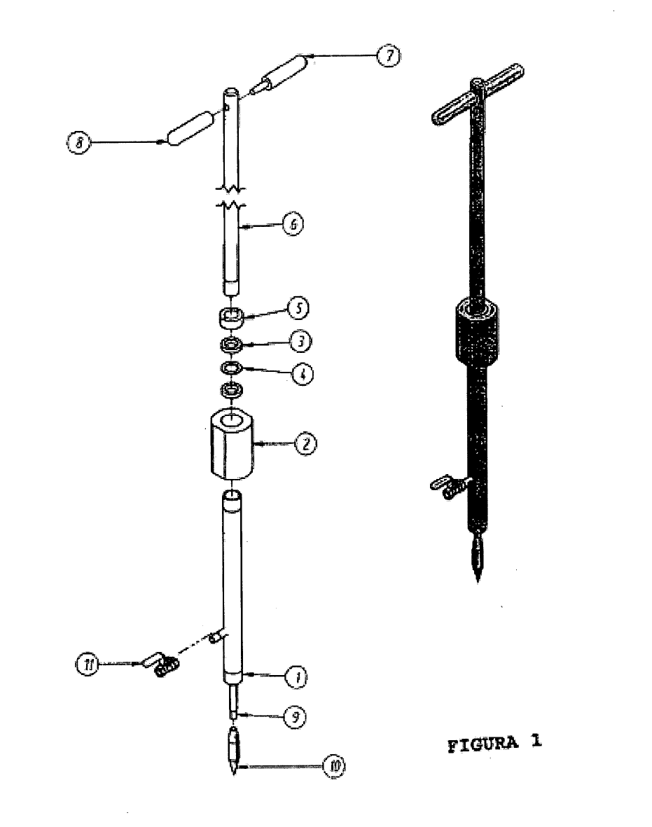

FIG. 2. Cross-section view of the tool for safely removing valves installed in fluid pipes.

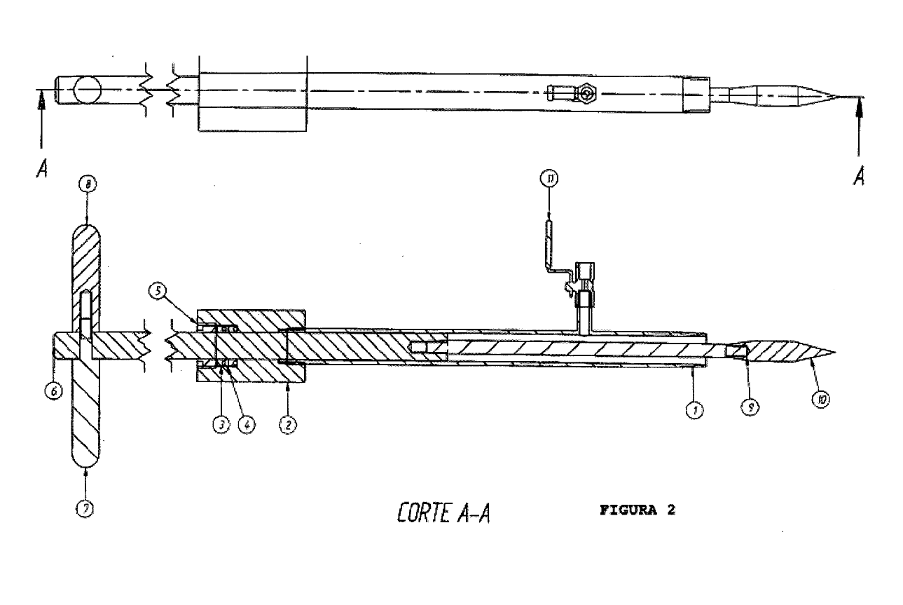

### DETAILED DESCRIPTION OF THE INVENTION

The tool for safely removing valves installed in fluid pipes comprises the following parts:

### Main Body

The main body (1) is constituted by a central tube which lodges the gauge (10) or the “calaján” required in a determined moment. It has a short tube with threaded ends, known as nipple and a drainage valve (11) for facilitating the calaján's seal testing and the internal pressure relief of the main body (1), generally these body and valve are made out of galvanized steel. There are two tandem lip seals (3) lodged at the top part, which avoid fluid leaks through the surface of the handle axle (6).

According to the illicit perforation diameter, there is a main body (1) which diameter is between 1½ in. (3.81 cm) and in. (5.08 cm) and a valve adaptor appropriate for each case. Both elements are made in carbon steel Sch. 40.

### Handle Axle

The handle axle or inner sliding body (6) connects to the gauge (10) or calaján with the outside. In its top end it has a bar at an angle of 90° for axially manipulation (during approaching of the gauge or calaján to the illicit perforation) or rotating (for unthreading the calaján in the last blocking steps).

Furthermore, on the smooth surface of the handle axle (6) the displacement measures necessary for controlling the calaján introduction process, can be marked with ink or chalk and during operation. In the same way, its top part can receive shocks with a bronze hammer in order to secure the calaján fit, when required.

The material of the handle axle (6) is an average medium alloy steel, with its ground central bar and dimensional tolerances for a lip type of seal.

### Gasket Carrier

The gasket carrier (2) is the element that lodges the gaskets themselves. It is a piece constructed in average alloy steel and has threaded connections and also a threaded seal fitness.

### Gasketing

The gasketing is the sealing element between the gasket carrier (2) and the handle axle (6). It is constituted by two seals made out of a special material (Vitón®) lip type (3) in tandem.

Gauge Adaptor/Calaján

This element (9) couples the handle axle (6) with the Gauge or Calaján (10).

### Undesired Valve Adaptors (Illicit)

This element engages the main body (1) with the undesired valve (illicit). Such as previously mentioned, there is an appropriate valve adaptor for each valve size (in this case the adaptors comprise reductions from 1½ in. to 1 in. (3.81 to 2.54 cm), 1½ in. to ¾ in. (3.81 to 1.905 cm), reductions from ¾ in. to ½ in. (1.905 to 1.27 cm), ¾ in. to ⅜ in. (1.905 to 0.925 cm), and ¾ in. to ¼ in. (1.905 to 0.635 cm), and all threaded nipples of 1 in. (2.54 cm), ¾ in. (1.905cm), ½ in. (1.27 cm), ⅜ in. (0.925 cm) and ¼ in. (0.635 cm).

### Gauges

The gauges are metal rods having one threaded end, used for measuring the diameter of the undesired perforation, through the pass-no-pass system. These rods are calibrated to fit the commercial drill bits diameters used in the undesired perforations: 0.792 cm, 0.9525 cm, 1.11 cm, 1.27 cm, 1.42 cm, 1.5875 cm, 1.722 cm, 1.905 cm, 2.06 cm, 2.22 cm, 2.38 cm, 2.54 cm, 2.7 cm, 2.8575 cm, 3.01 cm, 3.175 cm, 3.33 cm, 3.49 cm, 3.65 cm and 3.81 cm.

Calaján (Wooden Plug)

In the present invention an essential element is the wood type used as “calaján” because it must have special characteristics such as high hardness and low capillarity, in order to prevent the product to flow through the plug and generate vapor problems that can affect the safety in the welding process of the metal patch or “cascota”.

The Calaján is the consumable element used to physically block the undesired perforation, while installed through welding the “metal patch” or “cascota”.

The Calajans are constructed with high density wood (usually Tanané, Puy or Nazarene), possess a special cone shape and are machined with fitting tolerances of 0.070 in. (01778 cm) and 0.100 in. (0.254 cm) above the normal diameters of the above described gauges.

### ACCESSORIES

### Manometer

A Bourdon type manometer for pressures up to 300 psi (2068 kPa), is the measuring element of the internal pressure of the tool's main body (1). It is used to test the seal between the Calaján and the illicit perforation, during installation of the first.

### Drainage Valve

The drainage valve is a 0.635 cm ball type valve, installed in the same nipple where the Manometer is located, in the tool's Main Body (1). It is used, along with the Manometer, to test the seal between the Calaján and the illicit perforation, during its installation.

### “Cascota”

The “Cascota” is a metal piece having an elliptic and curved shape, manufactured from a tubing portion with the same specifications of that to which it will be welded to, and that is used to definitively cover the illicit perforation.

Support (Clip) for “Cascota”

The support or clip is a metal accessory having a C shape, used to clamp the “cascota” while welding it.

In the case of the tool of this invention, this is found configured to receive a closing force from a hydraulic cylinder, which can generate forces up to 10 Tons, with a hydraulic pressure of 10000 psi (68947 kPa), by means of a manual hydraulic pump.

The tool is constituted by a main body (1), formed by an outer tube containing a handle axle or inner sliding body (6) that can be engaged to a measuring element (10) named “gauge” and its extension (9) or wooden seal plug named “calaján”. The gauge is used to determine the diameter of the perforation to be blocked, through the “pass” or “not pass” calibration of the same. To that effect there is a gauge set calibrated to commercial diameters most frequently used in this type of taps. In addition, the main body (1) contains a side valve (11) used as drainage and relief of the internal pressure of the main body (1), and the testing of the wooden plug seal or calaján, and a seal set on its top part, formed by a threaded gasketing carrier (2), within which there are two tandem lip type seals (3) in order to prevent fluid leaks through the surface of the handle axle or inner sliding body (6), a sealing washer (4) and a gasketing carrier nut (5). The mentioned axle (6) has handles (7 and 8) located opposing to each other in order to an ease manipulation, axial displacement and manual control of the central axle or inner sliding body.

Depending on the perforation diameter, a main body (1) engages an appropriate valve adaptor in each case. These elements are made out of carbon steel.

### Method for Safely Removing Valves Installed in Fluid Tubes

The method for safely removing valves installed in fluid tubes with the tool previously described is carried out through the following steps described in detail below:
1. Determining the diameter of the valve located in the tap to be removed.
2. Measuring the distance between the outer edge of the line and the most external part of the valve to be removed and between the pole and the edge of the valve inner ball.
3. Selecting the adequate adaptor for the valve to be removed (dual thread element for diameter reduction and the nipple) and assembling it on the tool.
4. Selecting the calibration gauge to be used for determining the perforation diameter, for example for a one inch valve (2.45 cm) the following gauges will be used 1 in. (2.45 cm), 0.937 in. (2.38 cm), 0.875 in. (2.22 cm), 0.812 in. (2.06 cm), 0.750 in. (1.9 cm), 0.687 in. (1.74 cm), 0.625 in. (1.58 cm), 0.562 in. (1.42 cm) and 0.500 in. (1.27 cm) which are the diameters probably used to make the perforation.
5. Installing the measuring gauge on the tool; for the example of a 1 in. (2.54 cm) valve, we start installing the 0.750 in. (1.9 cm) gauge on the tool, but it can be started with the major diameter and going down or viceversa.
6. Measuring the distance between the duct surface and the edge of the valve body (Distance 1).
7. Then, internally measuring the distance between the bottom of the valve and the outer edge of the valve (Distance 2). The difference between distance 1 and distance 2 (Distance 3) is calculated.
8. Opening the drainage valve keeping the valve to be removed closed, then installing the tool (main body (1) and valve adaptor) screwing into the valve to be removed.
9. Introducing the axle of the handle of tool onto the valve to be removed, until the measuring gauge contacts the top part of the ball of the illicit valve; transporting and marking the distance 3 in the axle of the tool, this mark 3 will indicate when the gauge tip is at the edge of the perforation.
10. Next to mark 3 another line is drawn in the axle of the tool 8 cm apart from it (mark 4). This mark corresponds to the 8 cm height of the cone piece in the edge of the perforation, during the introduction of the “calaján”.
11. Then, another line is drawn (mark 5) on the tool axle two centimeters apart from mark 4; this is the indication that the cylinder part of the measuring gauge has passed on through the illicit perforation.
12. Closing the drainage valve of the tool.
13. Holding the handle axle (6) of the tool and slowly opening the illicit valve.
14. Pushing the handle axle (6) of the tool towards the illicit valve until the last line (mark 5) disappears in the gasketing carrier (2) of the tool; this means that the cylinder part of the gauge passes through the hole.
15. Drawing back the axle (6) of the tool to its initial point and closing the illicit valve. Opening the drainage valve (11) of the tool for pressure relief and draining into a bucket. Removing the tool and the measuring gauge and installing the next up or down gauge depending on if the initial rod passed or not through the perforation, and reinitiating the process from step (11). Once the contiguous calibration gauge diameters have been determined which pass through the perforation and which do not pass through, the Calaján to be installed is selected, from the following two cases:

Case 1: The inner diameter of the nipple on which the illicit valve is mounted is greater than the diameter of the hole. This case can be deduced because mark 4 or second line almost disappears in the gasketing carrier (2) of the tool. For this case:
16. Installing a Calajan on the tool, which is 0.254 cm (0.100 in.) thicker than the gauge measure which passed through the hole.
17. Installing the tool on the illicit valve through the respective valve adaptor.
18. Opening the drainage valve (11) of the tool.
19. Pushing the handle axle (6) of the tool until the Calajan contacts the top part of the illicit valve ball.
20. Closing the drainage valve (11).
21. Slowly opening the illicit valve and pushing the handle axle (6) of the tool against the tube, and hitting with a bronze hammer the handle axle (6) for securing a tight fit of the Calaján into the illicit perforation.
22. Opening the drainage valve (11) and testing for no product output.
23. Turning the handle axle (6) of the tool towards the left, for unscrewing the Calaján carrier cup of the tool.
24. Removing the tool.
25. Cutting the Calajan with a hacksaw blade for removing the Calaján carrier cup.
26. Unscrewing the illicit valve making sure the Calaján does not move.
27. Cutting the Calaján at a distance of more or less one inch (2.54 cm) from the nipple, and hitting again the Calaján with a hammer, to test the fitness.
28. Removing the illicit soldering with a polisher, and at the same time cooling it so that the Calaján does not burn and the seal is lost. Care must be taken in order to not affect the wood of the Calaján.
29. Cutting the Calaján flush with the tube, using a hacksaw.
30. Cleaning and profiling the tube surface, in an intent for keeping the same curvature.
31. Installing the Cascota (with its gasket) and positioning it in place with the help of a hydraulically driven C shaped press (the hydraulic driving is implemented to stop product leaks and thus avoiding changing a Calaján under high pressure, in order to carry out the welding).
32. Welding is done all around the edge of the “Cascota”.

Case 2: The inner diameter of the nipple on which the illicit valve is mounted is the same as the perforation diameter.

This case can be deduced because mark 4 or second line stays half the way, or at a distance equal to the nipple length on which the valve is mounted; in this case a calaján 0.178 cm (0.070 in.) thicker than the measure of the gauge that passed through the illicit perforation, is installed.

Care must be taken when this assembly is found given that the Calaján will initially seal in the nipple, and it becomes demanding to take the following measures in order to make sure that the cylinder part of the Calaján seals tightly on the tube of the line:
16. The exact length of the Calaján cone is measured and this measure is registered.
17. Installing in the tool using the Calaján carrier a Calaján 0.178 cm (0.070 in) thicker than the measuring gauge that passed through the illicit perforation.
18. Again installing the tool on the illicit valve.
19. Opening the drainage valve (11) of the tool.
20. Pushing the handle axle (6) of the tool until the Calajan contacts the top part of the illicit valve ball.
21. Closing the drainage valve (11).
22. Again a mark 4 is drawn in the handle axle (6) of the tool at a distance equal to the previously measured exact length of the calaján cone.
23. After the above mark has been made, then a mark is made on the handle axle (6) at a distance equal to that used in step (11); this mark indicates when the cylinder part of the Calaján will be on the illicit perforation.
24. Slowly opening the illicit valve and pushing the axle of the tool against the tube, hitting the axle with a bronze hammer for securing a tight fitness of the calaján into the hole, the axle of the tool must penetrate until the last made mark disappears in the tool.
25. Opening the drainage valve and testing that there is no product leakage.
26. Making a little groove in the base of the nipple with a hacksaw for testing that a seal was made with the tube, and if necessary the handle axle (6) of the tool is hit again in an intent to further introduce the calaján.
27. Turning the handle axle (6) of the tool towards the left for unscrewing the calaján carrier cup of the tool.
28. Removing the tool.
29. Cutting the calaján with a hacksaw blade without frame, for removing the calaján carrier cup.
30. Unscrewing the illicit valve making sure the calaján does not move.
31. Removing the illicit solder with a polisher and at the same time cooling the calajan so that it does not burn by the generated heat and the seal is lost.
32. Cutting the calaján flush with the tube, using a hacksaw.
33. Cleaning and profiling the tube surface, in an intent for keeping the same curvature.
34. Installing the Cascota (with its gasket) and positioning it in place with the help of a hydraulically driven C shaped press (the hydraulic driving is implemented to stop product leaks and thus avoiding changing a Calaján under high pressure, in order to carry out the welding).
35. Welding is done all around the edge of the “Cascota”.

1. Manual tool for safely removing valves installed in fluid pipes which allow the obstruction of undesired taps in fluid transport ducts comprising a main body, a handle axle, a gasketing carrier, a drainage valve, and a gauge adaptor or wooden plug.

2. The tool according to claim 1, wherein it allows the introduction of a temporary blocking element or calaján into the duct, while a definitive metal patch is installed.

3. The tool according to claim 1, wherein it is designed to be used even when the fluid transportation duct is operating.

4. The tool according to claim 1, wherein it is designed to be used with ducts for hydrocarbon transportation containing combusting vapors.

5. The tool according to claim 1, wherein it is designed to be used in hydrocarbon transportation ducts under present pressures up to 100 psi (690 kPa).

6. The tool according to claim 2, wherein the blocking element is a wooden made plug.

7. The tool according to claim 6, wherein the wooden plug is made with high density wood and having a special cone shape and machined with fitting tolerances of 0.070 in. (018 cm) and 0.100 in. (0.254 cm) above the normal diameters of the gauges.

8. The tool according to claim 1, wherein the main body is constituted by a central tube which lodges the gauge or the wooden plug, a nipple and a drainage valve, and two tandem lip seals are provided at the top part.

9. The tool according to claim 1, wherein the handle axle connects the gauge or plug with the outside and in its top end it has a bar at an angle of 90° for axially manipulating it (during approaching of the gauge or plug to the illicit perforation) or rotating it (for unthreading the plug in the last blocking steps).

10. The tool according to claim 1, wherein the gasketing is the sealing element between the gasket carrier and the handle axle, constituted by two seals made out of Vitón® lip type in tandem.

11. The tool according to claim 1, wherein the adaptor is the coupling element between the main body and the valve to be removed.

12. The tool according to claim 1, wherein the gauges are metal rods having a threaded end, used to measure the diameter of the illicit perforation, through the “pass-no pass” system.

13. The tool according to claim 11, wherein the gauges are calibrated to the commercial drill bits diameters used in the perforations of the valves to be removed.

14. A method for safely removing valves illicitly installed in fluid tubing, comprising the following steps:
a. Determining the diameter of the valve located in the tap to be removed.
b. Measuring the distance between the outer edge of the line and the most external part of the valve to be removed and between the pole and the edge of the valve inner ball.
c. Selecting the adequate adaptor for the valve to be removed (dual thread element for diameter reduction and the nipple) and assembling it on the tool.
d. Selecting the calibration gauge to be used for determining the perforation diameter, for example for a one inch valve (2.45 cm) the following gauges will be used 1 in. (2.45 cm), 0.937 in. (2.38 cm), 0.875 in. (2.22 cm), 0.812 in. (2.06 cm), 0.750 in. (1.9 cm), 0.687 in. (1.74 cm), 0.625 in. (1.58 cm), 0.562 in. (1.42 cm) and 0.500 in. (1.27 cm) which are the diameters probably used to make the perforation.
e. Installing the measuring gauge on the tool; for the example of a 1 in. (2.54 cm) valve, we start installing the 0.750 in. (1.9 cm) gauge on the tool, but it can be started with the major diameter and going down or vice versa.
f. Measuring the distance between the duct surface and the edge of the valve body (Distance 1).
g. Then, internally measuring the distance between the bottom of the valve and the outer edge of the valve (Distance 2). The difference between distance 1 and distance 2 (Distance 3) is calculated.
h. Opening the drainage valve keeping the valve to be removed closed, then installing the tool (main body (1) and valve adaptor) screwing into the valve to be removed.
i. Introducing the axle of the handle of tool onto the valve to be removed, until the measuring gauge contacts the top part of the ball of the illicit valve;
transporting and marking the distance 3 in the axle of the tool, this mark 3 will indicate when the gauge tip is at the edge of the perforation.
j. Next to mark 3, another line is drawn in the axle of the tool 8 cm apart from it (mark 4). This mark corresponds to the 8 cm height of the cone piece in the edge of the perforation, during the introduction of the “calaján”.
k. Then, another line is drawn (mark 5) on the tool axle two centimeters apart from mark 4; this is the indication that the cylinder part of the measuring gauge has passed on through the illicit perforation.
l. Closing the drainage valve of the tool.
m. Holding the handle axle of the tool and slowly opening the illicit valve.
n. Pushing the handle axle of the tool towards the illicit valve until the last line (mark 5) disappears in the gasketing carrier of the tool; this means that the cylinder part of the gauge passes through the hole.
o. Drawing back the axle of the tool to its initial point and closing the illicit valve. Opening the drainage valve of the tool for pressure relief and draining into a bucket. Removing the tool and the measuring gauge and installing the next up or down gauge depending on if the initial rod passed or not through the perforation, and reinitiating the process from step. Once the contiguous calibration gauge diameters have been determined, which pass through the perforation and which do not pass through, the Calaján to be installed is selected depending on the existing relationship between the inner diameter of the nipple on which the illicit valve is mounted on, and the hole diameter.

15. The method according to claim 14 wherein the inner diameter of the nipple on which the illicit valve is mounted is greater than the diameter of the hole and the method is comprising the following steps:
a. Installing a Calajan on the tool, which is 0.254 cm (0.100 in.) thicker than the gauge measure which passed through the hole.
b. Installing the tool on the illicit valve through the respective valve adaptor.
c. Opening the drainage valve of the tool.
d. Pushing the handle axle of the tool until the Calajan contacts the top part of the illicit valve ball.
e. Closing the drainage valve.
f. Slowly opening the illicit valve and pushing the handle axle of the tool against the tube, and hitting the handle axle with a bronze hammer for securing a tight fit of the Calaján into the illicit perforation.
g, Opening the drainage valve and testing for no product output.
h. Turning the handle axle of the tool towards the left, for unscrewing the Calaján carrier cup of the tool.
i. Removing the tool.
j. Cutting the Calajan with a hacksaw blade for removing the Calaján carrier cup.
k. Unscrewing the illicit valve making sure the Calaján does not move.
l. Cutting the Calaján at a distance of more or less one inch (2.54 cm) from the nipple, and hitting again the Calaján with a hammer, in order to test the fitness.
m. Removing the illicit soldering with a polisher and at the same time cooling it so that the Calaján does not get burned and the seal is not lost. Care must be taken in order to not affect the wood of the Calaján.
n. Cutting the Calaján flush with the tube, using a hacksaw.
o. Cleaning and profiling the tube surface, trying to keep the same curvature.
p. Installing the Cascota (with its gasket) and positioning it in place with the help of a hydraulically driven C shaped press (the hydraulic driving is implemented to stop product leaks and thus avoiding changing a Calaján under high pressure, in order to carry out the welding).
q. Welding is done all around the edge of the “Cascota”.

16. The method according to claim 14 wherein the inner diameter of the nipple on which the illicit valve is mounted is the same as the perforation diameter and the method is characterized by installing a calaján 0.178 cm (0.070 in.) thicker than the measure of the gauge that passed through the illicit perforation, wherein the Calaján will initially seal in the nipple and comprises the following:
a. The exact length of the Calaján cone is measured and this measure is registered.
b. Installing in the tool using the Calaján carrier a Calaján 0.178 cm (0.070 in) thicker than the measuring gauge that passed through the illicit perforation.
c. Again installing the tool on the illicit valve.
d. Opening the drainage valve of the tool.
e. Pushing the handle axle of the tool until the Calajan contacts the top part of the illicit valve ball.
f. Closing the drainage valve.
g. Again a mark 4 is drawn in the handle axle of the tool at a distance equal to the previously measured exact length of the calaján cone.
h. After the above mark has been made, then a mark is made on the handle axle at a distance equal to that used in step; this mark indicates when the cylinder part of the Calaján will be on the illicit perforation.
i. Slowly opening the illicit valve and pushing the axle of the tool against the tube, hitting the axle with a bronze hammer for securing a tight fitness of the calaján into the hole, the axle of the tool must penetrate until the last made mark disappears in the tool.
j. Opening the drainage valve and testing that there is no product leakage.
k. Making a little groove in the base of the nipple with a hacksaw for testing that a seal was made with the tube, and if necessary the handle axle of the tool is hit again for trying to further introduce the calaján.
l. Turning the handle axle of the tool towards the left for unscrewing the calaján carrier cup of the tool.
m. Removing the tool.
n. Cutting the calaján with a hacksaw blade without frame, for removing the calaján carrier cup.
o. Unscrewing the illicit valve making sure the calaján does not move.
p. Removing the illicit solder with a polisher and at the same time cooling the calajan so that it does not get burned by the generated heat and the seal is not lost.
q. Cutting the calaján flush with the tube, using a hacksaw.
r. Cleaning and profiling the tube surface, for trying to keep the same curvature.
s. Installing the Cascota (with its gasket) and positioning it in place with the help of a hydraulically driven C shaped press (the hydraulic driving is implemented to stop product leaks and thus avoiding changing a Calaján under high pressure, in order to carry out the welding).
t. Welding is done all around the edge of the “Cascota”.
